(19) United States
(12) Patent Application Publication
(10) Pub. No.: US 2023/0329191 A1
(43) Pub. Date: Oct. 19, 2023

(54) ADJUSTABLE PET FOOD CONTAINER

(71) Applicant: PetMedics LLC, New York, NY (US)

(72) Inventor: Jack Mizrahi, New York, NY (US)

(21) Appl. No.: 17/722,203

(22) Filed: Apr. 15, 2022

(51) Int. Cl. A01K 5/01

(52) U.S. Cl. CPC A01K 5/0114

(57) ABSTRACT

Adjustable pet food containers are generally described. Adjustable pet food containers may include a first component and a second component. The first component may include a base and a first portion coupled to the base and having a top surface disposed opposite of the base and an outer side surface extending upward from the base. The top surface may form a bottom of an enclosure having an open top. The second component may include an inner surface configured to engage along the outer side surface, such that a first portion of the inner surface extends above the top surface by a first amount and defines the sides of the enclosure.

### FIELD

This application relates to containers for serving pet food.

### BACKGROUND

Pet food containers are often made of wear-resistant materials such as metal or plastic to prevent deterioration over time. Pet food bowls often come in different sizes so that pet owners can select a pet food bowl that is appropriate for the size of their pet. For example, smaller feeding bowls may be used for smaller dogs since such dogs may require less food and/or may have trouble feeding from higher and/or larger bowls meant for larger dog breeds. Similarly, larger bowls may be used for large dogs that eat larger amounts of food. In some cases, stands may be used for pet food containers to making feeding more comfortable and/or to assist pets that suffer from musculoskeletal issues.

### SUMMARY

Systems and methods are provided for an adjustable pet food container. In accordance with embodiments of the present invention, adjustable pet food containers may comprise a first component comprising a base and a first portion coupled to the base. The first portion coupled to the base may have a top surface disposed opposite of the base and an outer side surface extending between the base and the top surface. In some examples, the top surface may form a bottom of an enclosure having an open top. In some embodiments, adjustable pet food containers may further comprise a second component including an inner surface configured to engage along the outer side surface, such that when the inner surface is engaged at a first position on the outer side surface, a first portion of the inner surface extends above the top surface by a first amount and defines the sides of the enclosure. In some examples, when the inner surface is engaged at a second position on the outer side surface, a second portion of the inner surface may extend above the top surface by a second amount, wherein the first amount is greater than the second amount. In some examples, when the inner surface is engaged at a lowest point along the outer side surface that is closest to the base, the enclosure may be associated with a minimum non-zero volume.

In some other embodiments, adjustable pet food containers may comprise a first component including a base and a cylindrical portion coupled to the base and having a top surface having a circular outer circumference disposed opposite of the base. In various examples, the cylindrical portion may include a first threaded portion disposed along at least a portion of an outer surface of the cylindrical portion. In some further examples, the top surface may form the bottom of an enclosure having an open top. In some cases, adjustable pet food containers may include a second component. The second component may include an inner surface comprising a second threaded portion configured to mate with the first threaded portion of the cylindrical portion such that the bowl component may be rotated in a first direction to move the bowl component away from the base along an axis of rotation and may be rotated in a second direction to move the bowl component toward the base along the axis of rotation. In various examples, a portion of the inner surface extending above the top surface may define the sides of the enclosure.

In various examples, methods of adjusting a pet food container are generally described. In various examples, the pet food container may comprise a first component engaged in contact with a second component. The method may comprise rotating the second component of the pet food container in a first direction around the first component of the pet food container, wherein the first component and the second component form an enclosure with an open top and wherein the rotating the second component of the pet food container in the first direction increases a volume of the enclosure. In various examples, the methods may further comprise rotating the second component of the pet food container in a second direction around the first component of the pet food container, wherein the rotating the second component of the pet food container in the second direction decreases the volume of the enclosure, wherein, when the second component is at a lowest point with respect to the first component, the volume of the enclosure is associated with a minimum non-zero value.

Still other embodiments of the present invention will become readily apparent to those skilled in the art from the following detailed description, wherein are described embodiments by way of illustrating the best mode contemplated for carrying out the invention. As will be realized, the invention is capable of other and different embodiments and its several details are capable of modifications in various obvious respects, all without departing from the scope of the present invention. Accordingly, the drawings and detailed description are to be regarded as illustrative in nature and not as restrictive.

### BRIEF DESCRIPTION OF DRAWINGS

FIG. 1A is an isometric view of an adjustable pet food container, in accordance with various aspects of the present disclosure.

FIG. 1B is an isometric view of a first component of the adjustable pet food container of FIG. 1A, in accordance with various aspects of the present disclosure.

FIG. 1C is an isometric view of a second component of the adjustable pet food container of FIG. 1A, in accordance with various aspects of the present disclosure.

FIGS. 2A-2D depict the adjustable pet food container of FIG. 1A in different configurations, in accordance with various aspects of the present disclosure.

FIG. 3A shows cross-sectional view of an adjustable pet food container in a first configuration, in accordance with various aspects of the present disclosure.

FIG. 3B shows a side view of the adjustable pet food container of FIG. 3A in the first configuration, in accordance with various aspects of the present disclosure.

FIG. 3C shows cross-sectional view of the adjustable pet food container of FIG. 3A in a second configuration, in accordance with various aspects of the present disclosure.

FIG. 3D shows a side view of the adjustable pet food container of FIG. 3A in the second configuration, in accordance with various aspects of the present disclosure.

FIG. 4 shows a view of the side of an adjustable pet food container labeled with graduated volumetric markings, in accordance with various aspects of the present disclosure.

FIG. 5 shows the side view of the adjustable pet food container including a threaded adjustment mechanism, in accordance with various aspects of the present disclosure.

FIG. 6A is an isometric view of a first component of the adjustable pet food container including a threaded adjustment mechanism, in accordance with various aspects of the present disclosure.

FIG. 6B is an isometric view of a second component of the adjustable pet food container including a threaded adjustment mechanism, in accordance with various aspects of the present disclosure.

FIG. 7A shows cross-sectional view of an adjustable pet food container in a first configuration, in accordance with various aspects of the present disclosure.

FIG. 7B shows cross-sectional view of the adjustable pet food container of FIG. 7A in a second configuration, in accordance with various aspects of the present disclosure.

### DETAILED DESCRIPTION

In accordance with embodiments of the present invention, adjustable pet food containers are generally described. Obesity and malnutrition are common health issues in some pets such as dogs and cats. Described herein is an adjustable pet food container that can be adjusted such that an enclosure formed by the adjustable pet food container is sized to hold an amount of food that is appropriate for the particular pet. For example, different sized dogs are recommended to eat different amount so food during a particular feeding session. The adjustable pet food containers described herein may be adjusted such that the enclosure of the pet food container can hold only the recommended amount of food without requiring a user to measure out the correct amount of food using measuring cups and/or by weight. Additionally, when the desired volume of food changes (e.g., such as when a pet's diet is changed at the recommendation of a veterinarian and/or as a pet grows and/or ages), the adjustable pet food container may be adjusted so that the enclosure holds the new recommended amount of food and not more.

In some examples, pet foods may have different recommended daily amounts (and/or per-meal amounts) for different sized pets. By way of example, a particular brand of dry dog food may recommend ¼-to 1 cup portions of the dry dog food each day for dogs up to 10 lbs, 1 to 1¾ cup portions of the dry dog food each day for dogs between 10 and 25 lbs, 1¾ to 3 cup portions of the dry dog food each day for dogs between 25 and 50 lbs, 3 to 4 cup portions of the dry dog food each day for dogs between 50 and 75 lbs, etc. As described in further detail below, the adjustable pet food containers described herein may be adjusted such that the volume formed by the enclosure of the adjustable pet food container holds the appropriate amount of food. Accordingly, after adjusting the adjustable pet food container to the appropriate volume, the pet owner may simply fill the adjustable pet food container without otherwise measuring the amount of food. Additionally, the pet food containers may be labeled with graduated markings that show the volume of the enclosure when the adjustable pet food container is adjusted to a particular configuration so that the pet owner knows what volume of food is held by the adjustable pet food container.

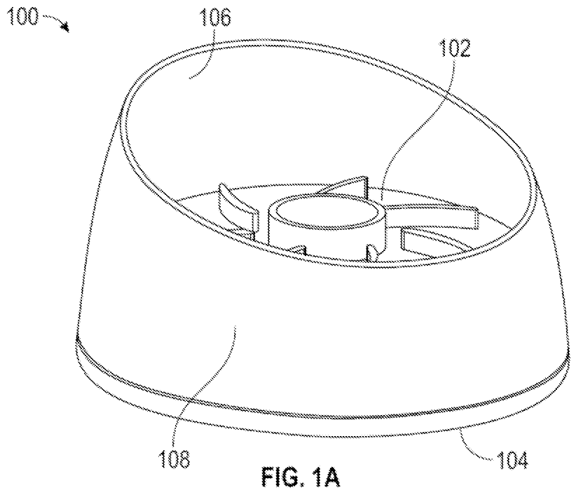

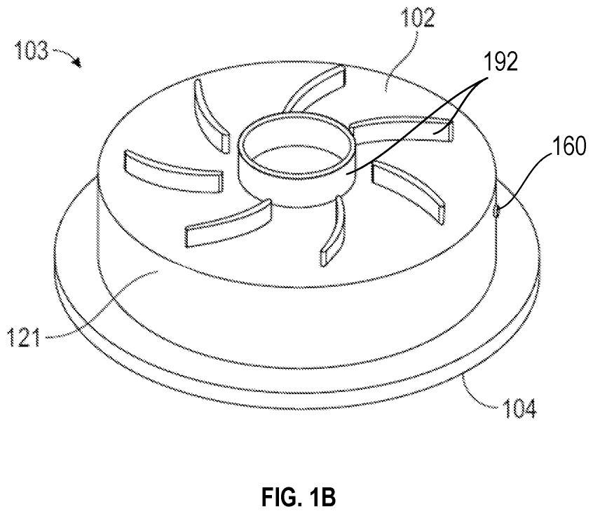

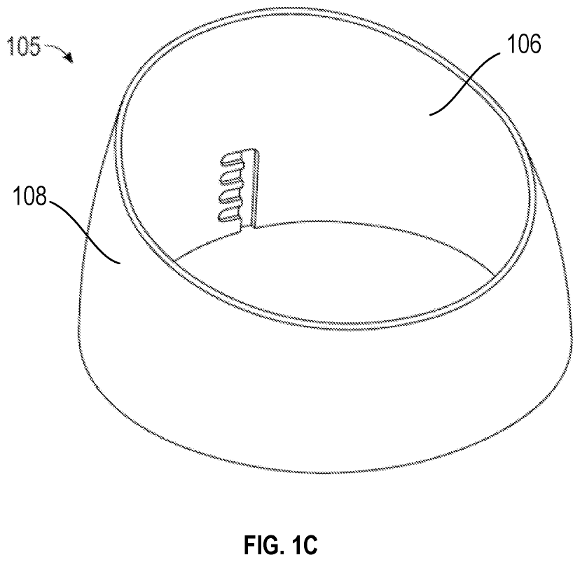

FIG. 1A includes an isometric view of an adjustable pet food container 100. FIG. 1B includes an isometric view of a first component 103 of the adjustable pet food container 100 and FIG. 1C includes an isometric view of a second component 105 of an adjustable pet food container, in accordance with various aspects of the present invention. The first component 103 of the adjustable pet food container 100 may include a base 104 and a top surface 102. The bottom of base 104 may be flat such that the base 104 may support the adjustable pet food container 100 on a flat surface (such as the floor). Although the base 104 of the adjustable pet food container 100 depicted in FIG. 1A is circular or semi-circular in shape, any desired shape may be used. The top surface 102 may be circular (as shown in FIG. 1A), or may be of some other shape, depending on the desired implementation. The top surface 102 of the first component 103 may form the bottom of an enclosure with an open top. The top surface 102 may be flat or may be of another shape or contour. For example, the top surface 102 may include a recess and/or may be concave. As shown in FIGS. 1A, 1B, the top surface 102 may include various features 192 (e.g., raised ridges and/or recesses). Such features 192 may aid in slowing the feeding of animals which may be beneficial for healthy digestion and may help to prevent over-eating. In addition, in some cases, the features 192 may allow for easier adjustment of the pet food container 100 (e.g., when adjusting the volume of the pet food container 100). For example, the features 192 may provide a grip that a user may use to hold the first component 103 in a fixed position while moving (e.g., raising, lowering, rotating, etc.) the second component 105. The first component 103 may include a first portion extending away from the base 104 and including the top surface 102. The sides of the enclosure may be formed by an inner surface 106 of the second component 105 of the adjustable pet food container 100.

Portions of the inner surface 106 may be configured to engage with portions of an outer side surface 121 of the first component 103. The outer side surface 121 of the first component 103 may be part of the first portion of the first component 103 that extends between base 104 and top surface 102. The second component 105 includes an outer surface 108. As described in further detail below, the second component 105 (including outer surface 108 and inner surface 106) may rest upon base 104 when the adjustable pet food container 100 is in a lowest configuration (e.g., when the adjustable pet food container 100 is in a configuration in which the second component 105 is disposed closest to the base 104). However, the second component 105 need not rest upon the base in the lowest configuration, but may instead be disposed in a spaced relationship with base 104.

The top surface 102 and the portion of the inner surface 106 of the second component 105 that extends beyond the top surface 102 (when first component 103 is engaged with second component 105) may form an enclosure having an open top. The enclosure may hold pet food or any other substance. The volume of the enclosure depends on the height at which the inner surface 106 of the second component 105 is engaged with the outer side surface 121 of the first component 103, as described in further detail below.

In various examples, the adjustable pet food container 100, the first component 103 and/or the second component 105 may be made of food grade plastic (e.g., polyethylene terephthalate (PET), polypropylene, high-density polyethylene (HDPE), polycarbonate, metal, and/or other food safe materials. In various examples, the top ridge of the second component 105 may be of variable height. For example, as shown in FIG. 1C, one side of the second component 105 may be higher than another. In at least some examples, this variable height may make the pet food container 100 more comfortable to feed from, as an animal may raise its head and mouth over the lower portion of second component 105. For example, the variable height or “tilted top” of the bowl may help a pet to consume and digest food as it does not require the pet to put their head directly downward to access food.

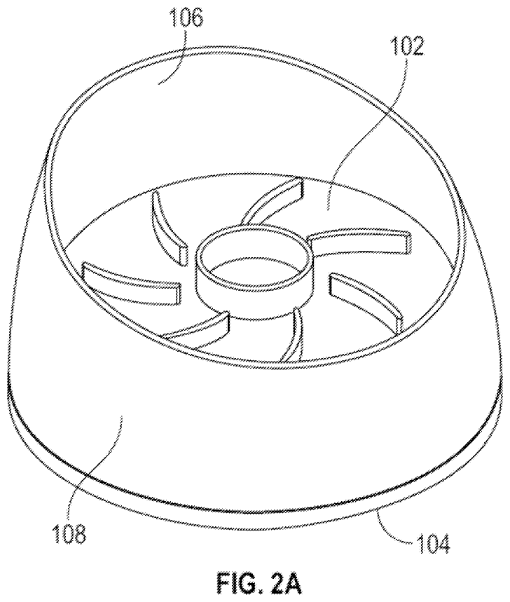

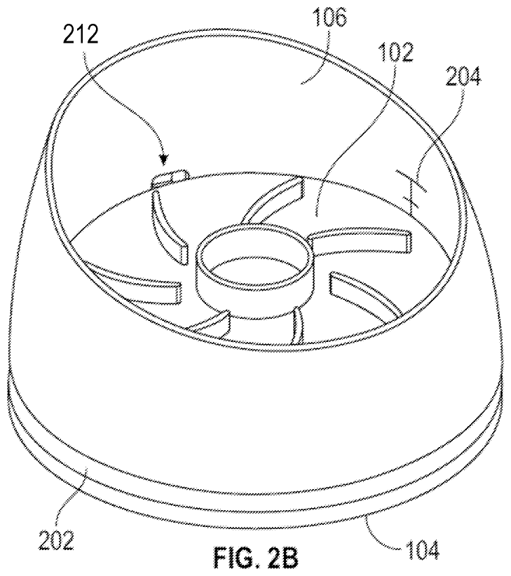

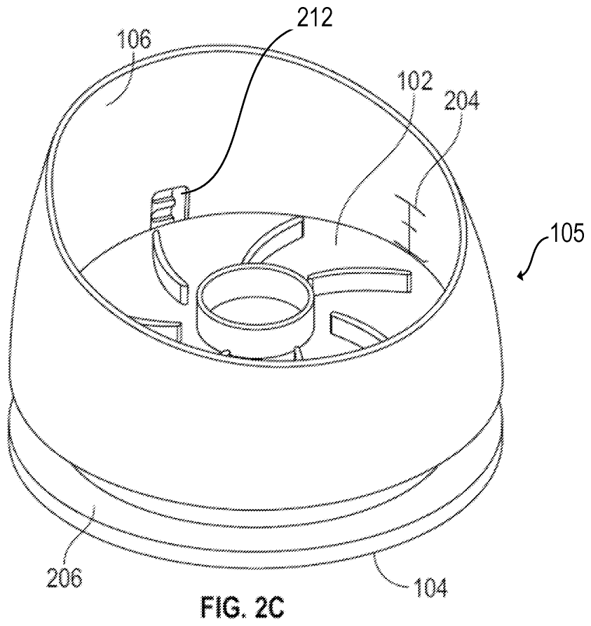

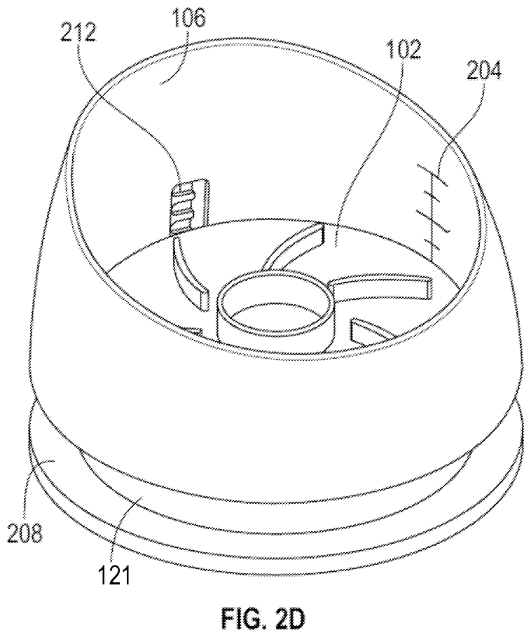

FIGS. 2A-2D depict the adjustable pet food container of FIG. 1 in different configurations, in accordance with various aspects of the present disclosure. Various components previously described in reference to FIG. 1 may not be described again in reference to FIGS. 2A-2D for purposes of brevity.

In FIG. 2A, the inner surface 106 of the second component 105 is engaged at a lowest point along the outer side surface 121 (not visible in FIG. 2A) of the first component 103 such that the enclosure of the adjustable pet food container is at a minimum volume. In various examples, even when the second component 105 is engaged along outer side surface 121 at the lowest point, as shown in FIG. 2A, some portion of the inner surface 106 may extend upward beyond the top surface 102 such that the enclosure may have a minimum non-zero volume that is effective to hold some amount of pet food (or other substance).

In FIG. 2B, the inner surface 106 of the second component 105 is engaged at a higher point along the outer side surface 121 of the first component 103 such that a greater amount of the inner surface 106 (relative to the configuration of FIG. 2A) may extend upward beyond the top surface 102, such that the enclosure has a greater volume relative to the configuration shown in FIG. 2A. In the example depicted in FIG. 2B, graduated volume indicator markings 204 are shown on the inner surface 106. The graduated volume indicator markings 204 may be positioned such that when a particular graduated indicator marking line is level with the top surface 102, the volume associated with that graduated indicator marking 204 is equal to the volume of the enclosure (to within a tolerance of 10% or some other desired tolerance). As shown in FIG. 2B, the second component 105 may be moved upward and away from the base 104, such that a gap 202 results between the bottom of the second component 105 and the base 104 as the second component 105 is engaged at a higher point along the side outer surface 121 of the first component 103.

In various examples, the inner surface 106 of the second component 105 may engage with different portions and/or positions of the outer side surface 121 of the first component 103 in different configurations and using a variety of different engagement mechanisms), depending on the desired implementation. For example, the inner surface 106 of the second component 105 may include a threaded portion with threads sized and shaped so as to mate with threads on the outer side surface 121 of the first component 103 such that the second component 105 may be rotated in a first direction to raise the second component 105 along the outer side surface 121 of the first component 103, and may be rotated in a second direction to lower the second component 105 along the outer side surface 121 of the first component 103. In other examples, the inner surface 106 of the second component 105 may engage along the outer side surface 121 of the first component 103 using friction in a piston/cylinder type configuration. In some such examples, portions of the inner surface 106 and/or the outer side surface 121 of the first component 103 may be made of a material (such as rubber) that allows the second component 105 to stay engaged at desired positions along the outer side surface 121 of the first component 103 via friction (e.g., to maintain a position of the second component 105 with respect to the first component 103 without falling to a lowest position due to gravity). The mechanism used to engage the inner surface 106 along the outer side surface 121 of the first component 103 may vary depending on the desired implementation. For example, while threads and/or friction based systems may be used in some examples, in other examples, a pin-and-groove mechanism wherein a pin 160 of the first component 103 fits into a groove in the second component 105 (or vice versa) to maintain a particular configuration of the first component 103 and second component. For example, a groove 212 of such a pin-and-groove mechanism is partially visible in FIG. 2B. Other engagement mechanisms known to those having ordinary skill in the art may be used as well.

In FIG. 2C, the inner surface 106 of the second component 105 is engaged at a higher point along the outer side surface 121 of the first component 103 (relative to either of the configurations in FIGS. 2A, 2B) such that a greater amount of the inner surface 106 (relative to the configuration of FIGS. 2A, 2B) extends upward beyond the top surface 102. In the configuration of FIG. 2C, the enclosure has a greater volume relative to either of the configurations shown in FIGS. 2A, 2B. Additionally, as the second component 105 has been moved further away from the base 104, gap 206 is larger relative to gap 202.

In FIG. 2D, the inner surface 106 of the second component 105 is engaged at an even higher point along the outer side surface 121 of the first component 103 (relative to the configurations depicted in FIGS. 2A, 2B, and 2C) such that a greater amount of the inner surface 106 (relative to the configuration of FIGS. 2A, 2B, 2C) extends upward beyond the top surface 102. In the configuration of FIG. 2D, the enclosure has a greater volume relative to the configurations shown in FIGS. 2A, 2B, and 2C. Additionally, as the second component 105 has been moved further away from the base 104, gap 208 is larger relative to gaps 202, 206. In the example of FIG. 2D, a pin on the outer side surface 121 of the first component 103 (the pin being hidden in the view of FIG. 2D) may be configured to engage (e.g., mate) with groove 212 along the inner surface 106 of the second component 105. Other adjustment mechanisms may be used. For example, instead of a pin-and-groove, there may be threads on outer side surface 121 that are configured to mate with threads on inner surface 106 of the second component.

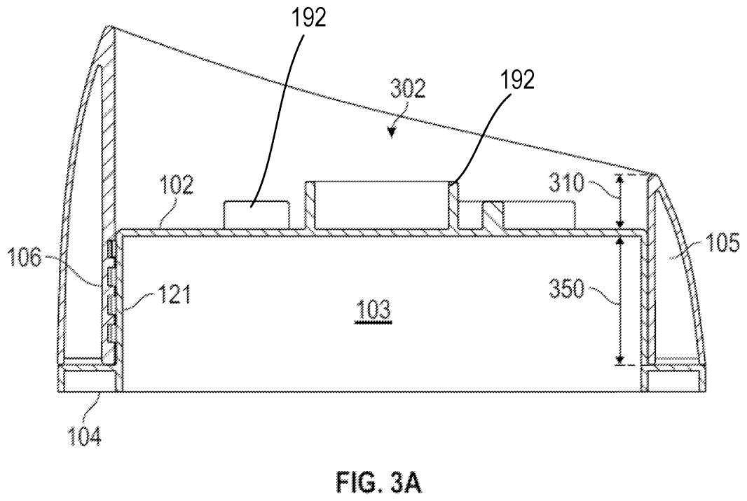

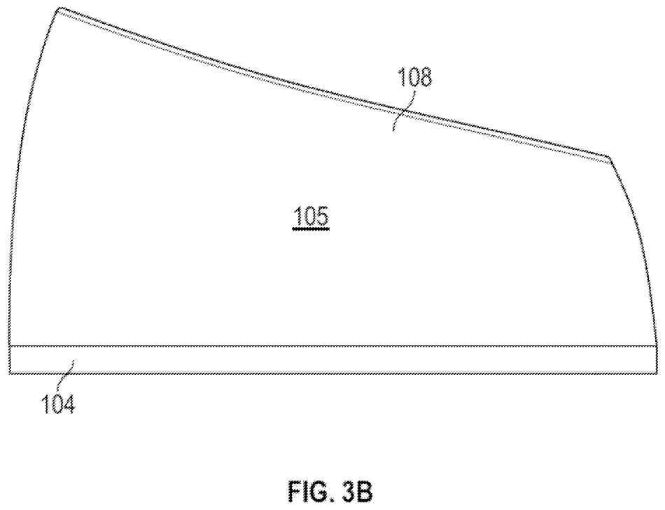

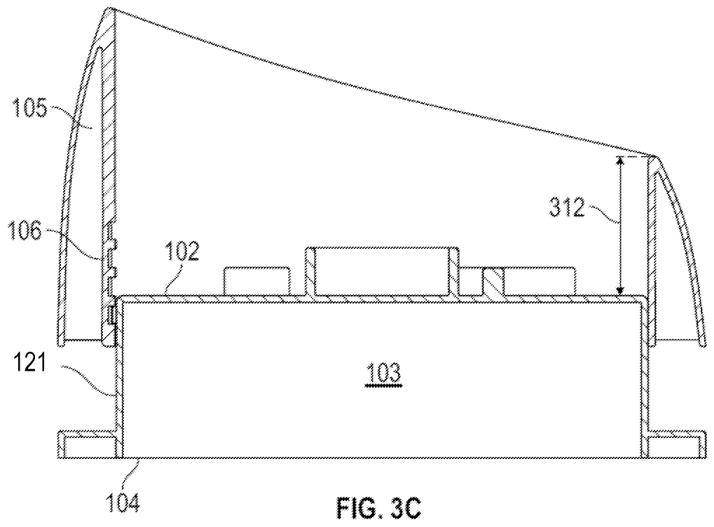

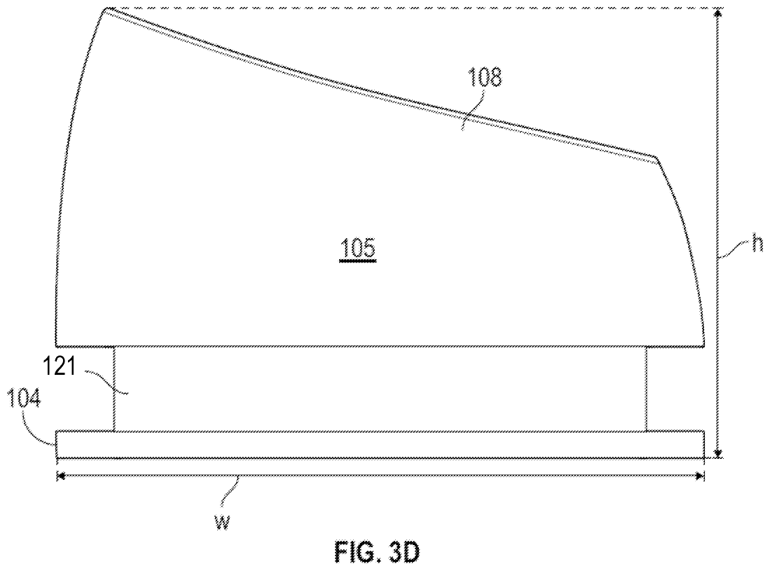

FIG. 3A shows cross-sectional view of an adjustable pet food container in a first configuration, in accordance with various aspects of the present disclosure. In FIG. 3A, the second component 105 is configured in a lowest position with respect to the first component 103. For example, a portion of the second component 105 is resting against a portion of base 104. Although, as previously described, in some examples, the second component 105 may not contact base 104 when the second component 105 is configured in a lowest position. In the lowest position depicted in FIG. 3A, the volume of the enclosure 302 formed by the top surface 102 of the first component 103 and by the portions of the inner surface 106 of second component 105 that extend above the top surface 102 is at a minimum, non-zero value. As shown in FIG. 3A, the inner surface 106 of the second component 105 extends above top surface by a first amount 310. The first component 103 and the second component 105 may be engaged via an engagement mechanism (e.g., teeth, friction between inner surface 106 and outer side surface 121, threads, etc.). In the example shown in FIG. 3A, first component 103 and second component 105 are engaged along distance 350 representing a contact surface between first component 103 and second component 105. However, in the event that top surface 102 is round when viewed from above (and the portion of first component 103 extending upward from base 104 is cylindrical), it should be noted that the outer side surface 121 (and the contact surface between first component 103 and second component 105) may extend around the cylinder and that, thus, the point(s) of contact between first component 103 and second component 105 may be at any one or more points and/or portions of the sides of the cylinder.

FIG. 3B shows a side view of the adjustable pet food container of FIG. 3A in the first configuration, in accordance with various aspects of the present disclosure. As shown, in this example, the second component 105 rests on the portions of the base 104 that extend laterally away from a central point of first component 103. However, in some examples, the second component 105 may extend downward to a surface upon which the adjustable pet food container rests and/or may be configured in a spaced relationship with respect to the base 104 and/or with respect to a surface on which the adjustable pet food container rests.

FIG. 3C shows a cross-sectional view of the adjustable pet food container of FIG. 3A in a second configuration, in accordance with various aspects of the present disclosure. In the example configuration depicted in FIG. 3C, the second component 105 may be at a maximum height. In other words, the inner surface 106 may be engaged with the outer side surface 121 at a maximum height along the outer side surface 121 (e.g., at a highest position). As such, the amount 312, by which the inner surface 106 extends beyond top surface 102 may be at a maximum. Accordingly, the volume of the enclosure formed by the top surface 102 of the first component 103 and by the portions of the inner surface 106 of second component 105 that extend above the top surface 102 may be at a maximum value and configured to hold the largest amount of food. In various examples, there may be a stop mechanism (e.g., a mechanical stop such as a protuberance (e.g., a protruding knob or flange) along inner surface 106 and/or outer side surface 121) effective to limit the amount by which the second component 105 may be raised (e.g., rotated in the case of helical threads) with respect to the first component 103. In some examples, there may be a similar stop mechanism at a lowest point effective to limit the amount by which the second component 105 may be lowered with respect to the first component 103. In the example depicted in FIG. 3C, there may be threads (not shown) on outer side surface 121. Accordingly, there may be corresponding threads (not shown) on inner surface 106 of second component 105 that are effective to mate with threads along outer side surface 121 of first component 103. As such, in the examples, the second component 105 may be raised or lowered by rotating the second component 105 with respect to the first component 103. Although, as previously described, any desired attachment and/or adjustment mechanism may be used in accordance with the desired implementation.

Although top surface 102 is shown as being flat (with raised features 192) in various examples herein, top surface 102 may instead be a different shape (e.g., concave, convex, and/or some other shape). For example, if the top surface 102 is concave (when viewed from the top), the enclosure may have a bowl-like shape, whereas if the top surface 102 is flat, the enclosure may have a cylindrical shape. In various examples, top surface 102 having a concave shape may be advantageous as it may be easier to clean and/or may provide easier pet feeding relative to other shapes. In various examples, the first component 103 may be removed from the second component 105 for cleaning.

FIG. 3D shows a side view of the adjustable pet food container of FIG. 3A in the second configuration, in accordance with various aspects of the present disclosure. When the second component 105 is configured in the highest position with respect to the first component 103 (as in the examples shown in FIGS. 3C, 3D), the height h of the adjustable pet food container (including both first component 103 and second component 105) may be less than the width w of the adjustable pet food container. This may be advantageous to prevent spilling and/or overturning the enclosure formed by the first component 103 and the second component 105. In various examples, the ratio of the width w to the height h may be at least 1.5:1 even when the adjustable pet food container is configured such that the volume of the enclosure is at a maximum volume (as in the examples of FIGS. 3C, 3D).

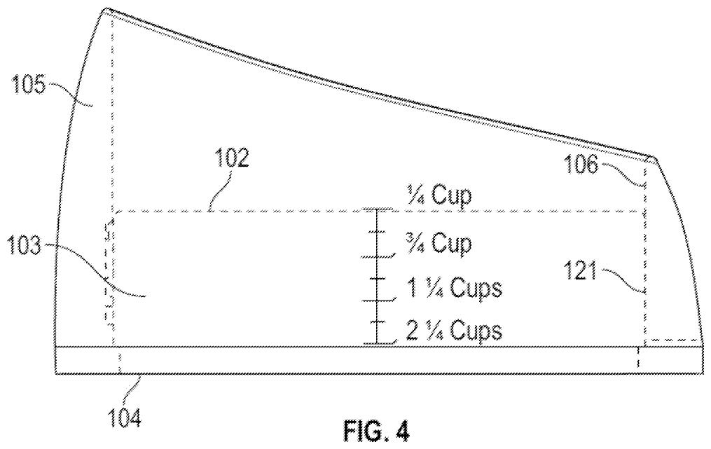

FIG. 4 shows a cut-away side view of an adjustable pet food container labeled with graduated volume indicator markings, in accordance with various aspects of the present disclosure. The inner surface 106 of second component 105 may include graduated volume indicator markings, similar to those shown in FIG. 4. The graduated volume indicator markings may be such that, when the first component 103 is engaged with the second component 105 (e.g., via one or more of the engagement mechanisms described herein), at least a portion of the top surface 102 may be aligned with a graduated volume indicator marking that corresponds to the volume of the enclosure of the adjustable pet food container to within a tolerance (e.g., +/−10% or some other tolerance depending on the manufacturing of the bowl and/or the accuracy of the graduated volume indicator markings).

In the example depicted in FIG. 4, the top surface 102 of the first component 103 is at approximately ¼ cup. Accordingly, the volume of the enclosure formed by top surface 102 and the portions of inner surface 106 that extend above the top surface 102 is approximately ¼ cup (e.g., dry measure or liquid measure, depending on the implementation). As the second component 105 is raised with respect to the first component 103 (e.g., by rotating the second component 105 if the engagement mechanism are helical threads), the volume of the enclosure increases. The top surface 102, however, remains in the same position, at the same height, but the portion of the inner surface 106 that extends above the top surface 102 has increased. Accordingly, the top surface 102 will be level with a different graduated volume indicator. In the example shown in FIG. 4, when the second component 105 is raised to a maximum height, the 2 and ¼ cups graduated volume indicator may be level with the top surface 102, indicating that the volume of the enclosure at such a configuration is approximately equal to 2 and ¼ cups (+/−some tolerance). It should be appreciated that the specific volumes (including the maximum and minimum volumes depend on the specific adjustable pet food container and the dimensions of its components.

While the invention has been described in terms of particular embodiments and illustrative figures, those of ordinary skill in the art will recognize that the invention is not limited to the embodiments or figures described. For example, in various embodiments described above, different engagement mechanisms are described as being used to engage first component 103 to the second component 105 in order to adjust the volume of the open-topped enclosure formed by the adjustable pet food container. However, other engagement mechanisms may be used in accordance with the desired design and/or manufacturing of the device.

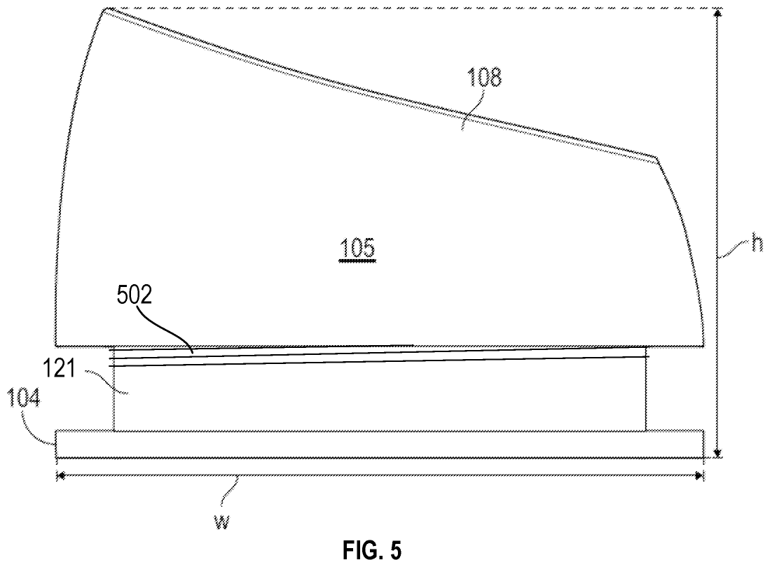

FIG. 5 shows the side view of the adjustable pet food container including a threaded adjustment mechanism, in accordance with various aspects of the present disclosure. For example, helical threads 502 are annularly disposed around the outer side surface 121 of the first component 103. Although not visible in FIG. 5, there may be threads along inner surface 106 of second component 105 that may mate with the threads 502. Accordingly, the second component 105 may be rotated with respect to the first component 103 to raise or lower the second component 105 with respect to the first component 103, thereby adjusting the volume of the enclosure.

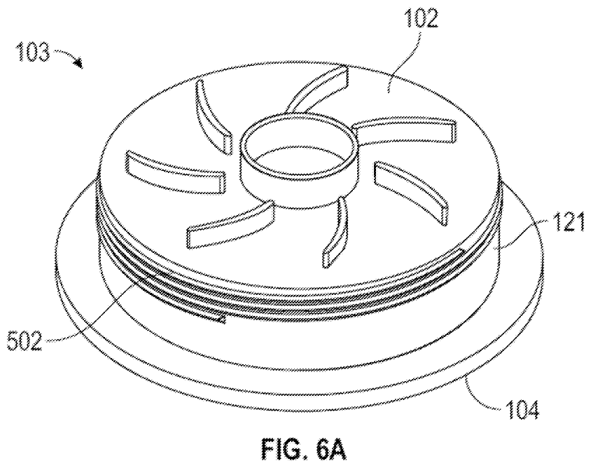

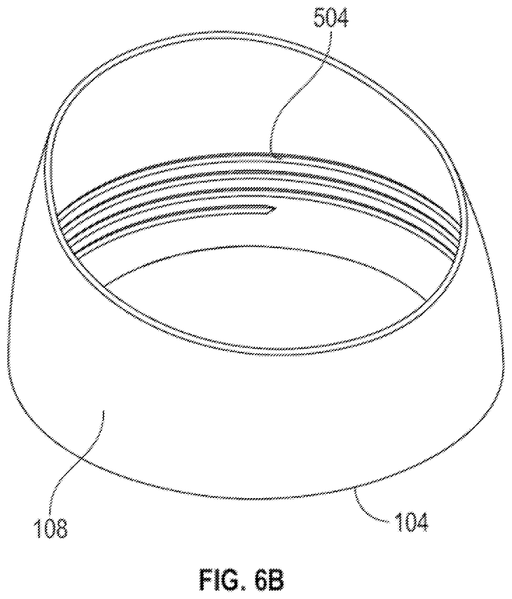

FIG. 6A is an isometric view of first component 103 of the adjustable pet food container including a threaded adjustment mechanism, in accordance with various aspects of the present disclosure. Those portions of FIG. 6A that have been shown and described above in reference to FIGS. 1-5 may not be described again for purposes of brevity. As shown, helical threads 502 are annularly disposed around the outer side surface 121 of first component 103. FIG. 6B is an isometric view of second component 105, which shows the helical threads 504 along the inner surface of second component 105. The helical threads 504 may be configured to mate with the helical threads 502 of the first component 103 as an adjustment mechanism. For example, the second component 105 may be rotated with respect to the first component 103 to raise the second component 105 (thereby increasing the volume of the enclosure) and lower the second component 105 (thereby decreasing the volume of the enclosure).

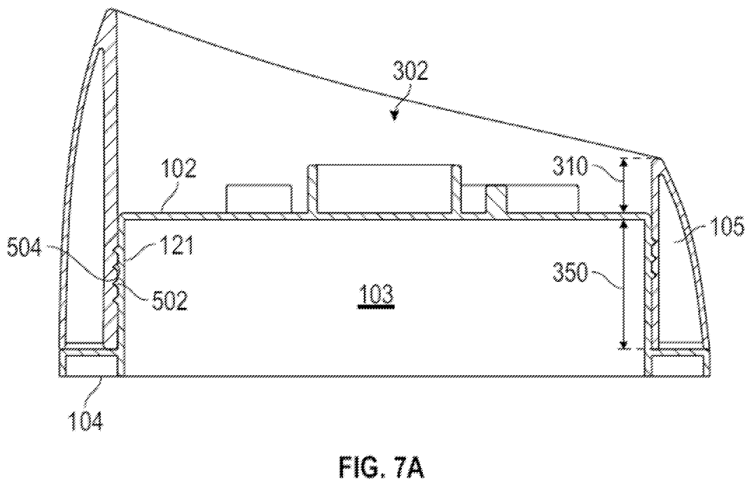

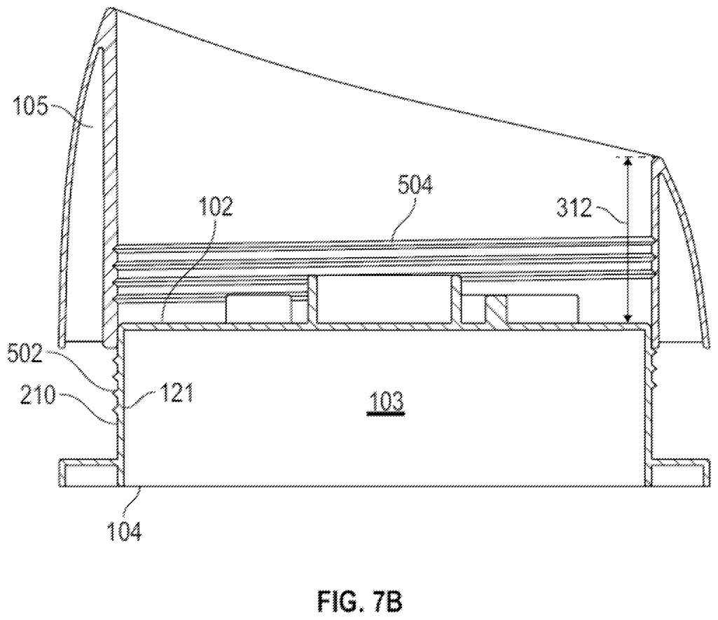

FIG. 7A shows cross-sectional view of an adjustable pet food container in a first configuration, in accordance with various aspects of the present disclosure. In the first configuration, the second component 105 is in a lowest configuration with respect to the first component 103. As shown, the helical threads 502 are engaged with helical threads 504, and the enclosure 302 is at a minimum positive volume.

FIG. 7B shows cross-sectional view of the adjustable pet food container of FIG. 7A in a second configuration, in accordance with various aspects of the present disclosure. In the second configuration, the second component 105 is in a highest configuration with respect to the first component 103. As shown, the helical threads 502 are engaged with helical threads 504 at a different, higher point along outer side surface 121, and the enclosure 302 is at a maximum positive volume. Those portions of FIGS. 7A-7B that have been shown and described above in reference to FIGS. 1-6B have not been described again for purposes of brevity.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one,” “at least one” or “one or more.” Unless otherwise required by context, singular terms used herein shall include pluralities and plural terms shall include the singular.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural and singular number, respectively. Additionally, the words “herein,” “above,” and “below” and words of similar import, when used in this application, shall refer to this application as a whole and not to any particular portions of the application.

The description of embodiments of the disclosure is not intended to be exhaustive or to limit the disclosure to the precise form disclosed. While specific embodiments and examples for the disclosure are described herein for illustrative purposes, various equivalent modifications are possible within the scope of the disclosure, as those skilled in the relevant art will recognize. Such modifications may include, but are not limited to, changes in the dimensions and/or the materials shown in the disclosed embodiments.

All of the references cited herein are incorporated by reference. Aspects of the disclosure can be modified, if necessary, to employ the systems, functions, and concepts of the above references and application to provide yet further embodiments of the disclosure. These and other changes can be made to the disclosure in light of the detailed description.

Specific elements of any foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. An adjustable pet food container, comprising:
a first component comprising:
a base; and
a first portion coupled to the base and having a top surface disposed opposite of the base and an outer side surface extending upward from the base, the top surface forming a bottom of an enclosure having an open top; and
a second component comprising:
an inner surface configured to engage along the outer side surface, such that when the inner surface is engaged at a first position on the outer side surface, a first portion of the inner surface extends above the top surface by a first amount and defines the sides of the enclosure, and such that when the inner surface is engaged at a second position on the outer side surface, a second portion of the inner surface extends above the top surface by a second amount, wherein the first amount is greater than the second amount, wherein, when the inner surface is engaged at a lowest point along the outer side surface that is closest to the base, the enclosure is associated with a minimum non-zero volume.

2. The adjustable pet food container of claim 1, wherein:
at least a portion of the outer side surface comprises a first threaded portion; and
at least a portion of the inner surface comprises a second threaded portion configured to mate with the first threaded portion, such that the second component may be rotated in a first direction to move the second component away from the base along an axis of rotation, and may be rotated in a second direction to move the second component toward the base along the axis of rotation.

3. The adjustable pet food container of claim 2, wherein rotation of the second component in the first direction results in a volume of the enclosure increasing.

4. The adjustable pet food container of claim 1, wherein the inner surface includes graduated volume indicator markings defining different volumes of the enclosure.

5. The adjustable pet food container of claim 4, wherein, when the first component and the second component are engaged such that a first graduated volume indicator marking on the inner surface of the second component is level with the top surface of the first component, a volume of the enclosure is equal to a value associated with the first graduated indicator marking to within a tolerance of 10%.

6. The adjustable pet food container of claim 1, the base as having a first width when viewed from above, wherein the top surface has a second width when viewed from above, the second width being smaller than the first width.

7. The adjustable pet food container of claim 6, wherein, when the second component is in a highest setting when engaged with the first component, a widest portion of the second component has a third width, when viewed from above, that is equal to the first width of the base, to within a tolerance of 10%.

8. The adjustable pet food container of claim 1, wherein a width of the base is greater than a height of the adjustable pet food container when the second component is engaged with outer side surface at a maximum height.

9. The adjustable pet food container of claim 1, wherein the outer side surface extends from the base to at least a portion of the top surface.

10. An adjustable pet food container, comprising:
a first component comprising:
a base; and
a cylindrical portion coupled to the base and having a top surface having a circular outer circumference disposed opposite of the base, wherein the cylindrical portion comprises a first threaded portion disposed along at least a portion of an outer side surface of the cylindrical portion, the top surface forming the bottom of an enclosure having an open top; and
a second component comprising:
an inner surface comprising a second threaded portion configured to mate with the first threaded portion of the outer side surface of the cylindrical portion such that the second component is rotatable in a first direction to move the second component away from the base along an axis of rotation and is rotatable in a second direction to move the second component toward the base along the axis of rotation, wherein a portion of the inner surface extending above the top surface defines the sides of the enclosure.

11. The adjustable pet food container of claim 10, wherein rotation of the second component in the first direction results in a volume of the enclosure increasing.

12. The adjustable pet food container of claim 10, wherein rotation of the second component in the first direction results in a volume of the enclosure increasing.

13. The adjustable pet food container of claim 12, wherein when the first component and the second component are engaged such that a first graduated volume indicator marking on the inner surface of the second component is level with the top surface of the first component, the volume of the enclosure is equal to a value associated with the first graduated indicator marking to within a tolerance of 10%.

14. The adjustable pet food container of claim 10, wherein when rotation of the second component in the second direction causes the second component to engage with the inner surface at a lowest point, a volume of the enclosure is at a minimum positive value.

15. The adjustable pet food container of claim 10, wherein a width of the base is greater than a height of the adjustable pet food container when the second component is engaged with the outer side surface at a maximum height.

16. A method of adjusting a pet food container, the pet food container comprising a first component engaged in contact with a second component, the method comprising:
rotating the second component of the pet food container in a first direction around the first component of the pet food container, wherein the first component and the second component form an enclosure with an open top and wherein the rotating the second component of the pet food container in the first direction increases a volume of the enclosure; and
rotating the second component of the pet food container in a second direction around the first component of the pet food container, wherein the rotating the second component of the pet food container in the second direction decreases the volume of the enclosure, wherein, when the second component is at a lowest point with respect to the first component, the volume of the enclosure is associated with a minimum non-zero value.

17. The method of claim 16, wherein the second component comprises an inner surface configured to engage along an outer side surface of the first component, such that when the inner surface is engaged at a first position on the outer side surface, a first portion of the inner surface extends above the top surface by a first amount and defines the sides of the enclosure.

18. The method of claim 16, wherein the inner surface includes graduated volume indicator markings defining different volumes of the enclosure.

19. The method of claim 16, wherein, when the first component and the second component are engaged such that a first graduated volume indicator marking on the inner surface of the second component is level with the top surface of the first component, the volume of the enclosure is equal to a value associated with the first graduated indicator marking to within a tolerance of 10%.

20. The method of claim 16, wherein a width of a base of the first component is greater than a height of the pet food container when the second component is engaged with an outer side surface at a maximum height.
